(19) United States
(12) Patent Application Publication
(10) Pub. No.: US 2026/0301049 A1
(43) Pub. Date: Oct. 1, 2026

(54) MACHINE LEARNING PLATFORM FOR RECOMMENDING SAFE VEHICLE SEATS

(71) Applicant: STATE FARM MUTUAL AUTOMOBILE INSURANCE COMPANY AUTOMOBILE INSURANCE COMPANY, Bloomington, IL (US)

(72) Inventors: Brian Mark Fields, Phoenix, AZ (US); Anish Agarwal, Chandler, AZ (US); Justin Wyatt Montgomery, Normal, IL (US); Alex Reed, Normal, IL (US); Joshua John Freitas, Peoria, AZ (US); Hassan Boukhamseen, Champaign, IL (US); Melissa Collette Miles, Normal, IL (US); Catherine Espel-Logan, Plano, TX (US)

(21) Appl. No.: 19/702,057

(22) Filed: Jun. 9, 2026

Related U.S. Application Data
(63) Continuation of application No. 18/386,961, filed on Nov. 3, 2023.
(60) Provisional application No. 63/422,570, filed on Nov. 4, 2022.

(51) Int. Cl. G06Q 30/0601

(52) U.S. Cl. CPC G06Q 30/0631

(57) ABSTRACT

Methods and systems for recommending safe vehicle seats and/or predicting the replacement time of vehicle seats. The systems and methods may include (1) training a machine learning model using a set of characteristics of previously recommended vehicle seats to generate a vehicle seat recommendation score for one or more vehicle seats; (2) receiving a request for a vehicle seat recommendation; (3) receiving input data; (4) determining a set of characteristics of the input data; (5) applying the set of characteristics of the input data to the machine learning model to generate a vehicle seat recommendation score for the one or more vehicle seats; (6) ranking the one or more vehicle seats by vehicle seat recommendation score to generate a vehicle seat recommendation list; and/or (7) presenting the vehicle seat recommendation list to a client device.

### CROSS REFERENCE TO RELATED APPLICATIONS

The present application is a continuation of U.S. patent application Ser. No. 18/386,961, entitled “Machine Learning Platform for Recommending Safe Vehicle Seats,” filed on May 9, 2024, which claims priority to and the benefit of the filing date of U.S. Provisional Patent Application No. 63/422,570, entitled “Machine Learning Platform for Recommending Safe Vehicle Seats,” filed on Nov. 4, 2022, the entire contents of which are hereby expressly incorporated herein by reference.

### TECHNICAL FIELD

The present disclosure generally relates to machine learning algorithms, techniques, platforms, methods, and systems for recommending safe vehicle seats and/or predicting the replacement time of vehicle seats.

### BACKGROUND

Installing proper seats in vehicles is critical in ensuring the safety of toddlers and children. However, vehicle owners and operators face several challenges in both selecting and installing the proper seat for a child or toddler.

As an initial problem, despite the large selection of seats available, vehicle seats have no industry standard in terms of installation and vehicle compatibility. As such, drivers need to first determine which seats are able to be installed in their vehicle.

Additionally, toddler seats and child seats are only safe for toddlers and children up to a certain height and weight. Once the child grows past that height and/or weight, the operator must replace that vehicle seat with another. This process may repeat every few years until the child reaches the minimum height and/or weight for standard adult seats. To make matters worse, many vehicle and seat manufacturers only list the recommended age range of toddlers and children. As such, operators often need to find and/or measure the dimensions of potential vehicle seats as well as its weight limit to determine if it is appropriate for their child.

Moreover, seats that fit the above criteria—i.e., seats that are appropriate for the height and weight of the child and may be properly installed in the vehicle—are not necessarily the best seats on the market. To select a seat, drivers may have to sift through countless reviews to determine if the product has hidden defects, installation quirks, comfort problems, and/or the like. Conventional techniques may include additional safety issues, inefficiencies, encumbrances, ineffectiveness, and/or other drawbacks as well.

### SUMMARY

In some embodiments, a computer-implemented method for predicting the time to replace one or more vehicle seats may be provided. The method may be implemented via one or more local or remote processors, transceivers, sensors, servers, memory units, mobile devices, wearables, and/or other electronic or electrical components. In one instance, the method may include: (1) training, by one or more processors, a machine learning model for predicting a replacement time of one or more vehicle seats using (i) a set of characteristics of a previously recommended vehicle seat and (ii) replacement times for the previously recommended vehicle seat, wherein the machine learning model includes one or more layers having one or more corresponding weights, and training the machine learning model includes (a) determining whether a validation metric associated with the machine learning is satisfied, and (b) when the validation metric is satisfied, retraining the machine learning model by modifying the one or more weights; (2) receiving, by the one or more processors, input data related to a previously recommended vehicle seat; (3) determining, by the one or more processors, a set of characteristics of the input data; (4) applying, by the one or more processors, the set of characteristics of the input data to the machine learning model to determine the predictive replacement time for replacing the one or more vehicle seats; and (5) providing, by the one or more processors, an indication of the predictive replacement time for display on a client device. The method may include additional, less, or alternate actions, including those discussed elsewhere herein.

In other embodiments, a computer system for predicting the time to replace one or more vehicle seats may be provided. The computer system may include, or be configured to work with, one or more local or remote processors, transceivers, sensors, servers, memory units, mobile devices, wearables, and/or other electronic or electrical components. In one instance, the computing system may include one or more processors and associated transceivers, and a non-transitory program memory coupled to the one or more processors and storing executable instructions that, when executed by the one or more processors, cause the computer system to: (1) train a machine learning model for predicting a replacement time of one or more vehicle seats using (i) a set of characteristics of a previously recommended vehicle seat and (ii) replacement times for the previously recommended vehicle seat, wherein the machine learning model includes one or more layers having one or more corresponding weights, and training the machine learning model includes (a) determining whether a validation metric associated with the machine learning is satisfied, and (b) when the validation metric is satisfied, retraining the machine learning model by modifying the one or more weights; (2) receive input data related to a previously recommended vehicle seat; (3) determine a set of characteristics of the input data; (4) apply the set of characteristics of the input data to the machine learning model to determine the predictive replacement time for replacing the one or more vehicle seats; and (5) provide an indication of the predictive replacement time for display on a client device. The computer system may be configured to include additional, less, or alternate functionality, including that discussed elsewhere herein.

In yet other embodiments, a tangible, a non-transitory computer-readable medium for predicting the time to replace one or more vehicle seats may be provided. The executable instructions, when executed by one or more processors of a computer system, cause the computer system to: (1) train a machine learning model for predicting a replacement time of one or more vehicle seats using (i) a set of characteristics of a previously recommended vehicle seat and (ii) replacement times for the previously recommended vehicle seat, wherein the machine learning model includes one or more layers having one or more corresponding weights, and training the machine learning model includes (a) determining whether a validation metric associated with the machine learning is satisfied, and (b) when the validation metric is satisfied, retraining the machine learning model by modifying the one or more weights; (2) receive input data related to a previously recommended vehicle seat; (3) determine a set of characteristics of the input data; (4) apply the set of characteristics of the input data to the machine learning model to determine the predictive replacement time for replacing the one or more vehicle seats; and (5) provide an indication of the predictive replacement time for display on a client device. The instructions may direct additional, less, or alternate functionality, including that discussed elsewhere herein.

The present disclosure may include improvements in computer functionality or in improvements to other technologies at least because the disclosure herein discloses systems and methods for recommending vehicle seats and/or predicting the replacement of vehicle seats. The systems and methods herein may train machine learning models using input data vectors (e.g., prior requests for vehicle seat recommendations, prior vehicle seat recommendations and actually purchased and/or installed vehicle seats, times between prior requests and/or recommendations and/or the like) to generate confidence values regarding the likelihood a vehicle recommendation will actually be purchased and/or installed in a vehicle. For example, when deployed within the underlying system, the machine learning models allow the systems and methods of the present disclosure to use fewer computing resources than related, conventional practices, at least because such conventional practices would require manual data entry, data storage, and/or implementation, all of which result in greater memory usage and processor utilization.

Additional improvements may also include practical applications for the improvement of technology. For example, the system, utilizing the machine learning models, may be able to determine whether a vehicle seat is in need of replacement (e.g., in the event of a collision, or based upon calculated growth rate of the passengers of the vehicle). In addition, the present disclosure solves the above-described problem related to the proliferation of improperly selected vehicle seats, to further improve the safety of vehicle passengers.

Similarly, the present disclosure describes improvements in the functioning of the computer or “any other technology or technical field” because the data generated (e.g., the confidence values) described herein allows the underlying computer system to utilize less processing and memory resources compared to prior art systems and methods. This is at least because the machine learning models can generate and/or determine data regarding the likelihood of a vehicle seat being selected and installed in a vehicle without the need for various tests and/or empirical computer simulation across a wide range of tests using multiple compute cycles and data. Therefore, use of the machine learning models results in fewer compute cycles, or otherwise iterations, that has less of an impact on the underlying computing device compared to previous prior art systems and methods.

Advantages will become more apparent to those of ordinary skill in the art from the following description of the preferred embodiments, which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various embodiments of the systems and methods disclosed herein. It should be understood that the figures depict illustrative embodiments of the disclosed systems and methods, and that the figures are intended to be exemplary in nature. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and instrumentalities shown, wherein:

FIG. 1 depicts an exemplary computing device including components and apparatuses for implementing the vehicle seat recommendation system and/or the predictive replacement time system in accordance with some embodiments;

FIG. 2 depicts an exemplary computing system including components and apparatuses for implementing the vehicle seat recommendation system and/or the predictive replacement time system in accordance with some embodiments;

FIG. 3 depicts an exemplary machine learning training module in accordance with some embodiments;

FIG. 4A depicts an exemplary flowchart representative of example methods, hardware logic, and instructions for implementing the vehicle seat recommendation system in accordance with some embodiments;

FIG. 4B depicts an exemplary flowchart representative of example methods, hardware logic, and instructions for implementing the predictive replacement time system in accordance with some embodiments;

FIG. 5 depicts an exemplary flowchart representative of example methods, hardware logic and instructions for training and validating the machine learning models in accordance with some embodiments;

FIG. 6A depicts an exemplary user interface in accordance with some embodiments;

FIG. 6B depicts an exemplary user interface in accordance with some embodiments;

FIG. 7 depicts an exemplary computer-implemented method for recommending a vehicle seat in accordance with some embodiments; and

FIG. 8 depicts an exemplary computer-implemented method for predicting the replacement time of a vehicle seat in accordance with some embodiments.

The figures depict the present embodiments for purposes of illustration only. One skilled in the art will readily recognize from the following discussion that alternate embodiments of the structures and methods illustrated herein may be employed without departing from the principles of the invention described herein.

### DETAILED DESCRIPTION

To assist operators of vehicles with the selection and replacement of vehicle seats, systems and methods for recommending vehicle seats and/or predicting the replacement of vehicle seats are presented.

In a first embodiment, a computer system may recommend one or more vehicle seats for a vehicle. A user may enter input data using a user device relating to the vehicle (e.g., the make, model, year, etc. of the vehicle), the current vehicle seat installed (e.g., the make, model, etc. of the vehicle seat), a passenger of the vehicle (e.g., the age, weight, etc. of the passenger). The user device may transmit the input data to the computer system for processing. Upon receiving the input data, the computer system may analyze the image data to: (i) recommend a vehicle seat and/or (ii) predict the replacement time of a vehicle seat. In some embodiments, the computer system may also determine whether any of the recommended vehicle seats are available for purchase on-line as well as determine (i) the cheapest vehicle seat recommended that is available for purchase, (ii) vehicle seats in stores in closest proximity to the operator, and/or (iii) purchase and/or order one or more vehicle seats selected by the operator. The computer system may apply machine learning techniques during analysis. In some embodiments, the computer system may poll with the operator to ask if any of the recommended vehicle seats have been purchased and/or installed in the vehicle. The computer system may be re-trained using the response from the operator and entered input data as training data.

In a second embodiment, a computer system may predict when a vehicle seat is due for replacement. A computer system (e.g., a remote application server, a computer coupled to the vehicle, etc.) may analyze input and/or output data of the vehicle seat recommendation system (e.g., the make, model, year, etc. of the vehicle, the one or more vehicle seats recommended, and/or the like) as well as the response of the operator from the poll (e.g., to determine if any of the recommended vehicle seats are the currently installed vehicle seat). In some embodiments, the computer system may calculate a growth rate of a passenger of the vehicle to estimate the time the vehicle seat needs to be replaced.

It should be appreciated that this description may be extended to all vehicle seats commercially available and not just those for toddlers and/or children. For example, if an adult desires to replace a vehicle seat in their vehicle, they may still use the systems, methods, and/or techniques described herein to obtain a vehicle seat recommendation for a vehicle seat that may be purchased and installed in their vehicle. Similarly, for adults who are not able to sit safely inside the prototypical adult size vehicle seats (e.g., due to their particular height and/or weight), may require specialized vehicle seats to accommodate their specific height and/or weight, and the systems, methods, and/or techniques described herein may be used obtain a vehicle seat recommendation for a vehicle seat that may be purchased and installed in their vehicle to allow them to drive safely.

### Exemplary Machine Learning Techniques

The present embodiments may involve, inter alia, the use of cognitive computing, predictive modeling, machine learning, and/or other modeling techniques and/or algorithms. In particular, vehicle information, child information, seat information, and/or the like may be input into one or more machine learning programs described herein that are trained and/or validated to recommend a vehicle seat and/or predict the replacement of a vehicle seat.

In certain embodiments, the systems, methods, and/or techniques discussed herein may use heuristic engines, algorithms, machine learning, cognitive learning, deep learning, combined learning, predictive modeling, and/or pattern recognition techniques. For instance, a processor and/or a processing element may be trained using supervised or unsupervised machine learning, and the machine learning program may employ a neural network, which may be a convolutional neural network (CNN), a fully convolution neural network (FCN), a deep learning neural network, and/or a combined learning module or program that learns in two or more fields or areas of interest. Machine learning may involve identifying and/or recognizing patterns in existing data in order to facilitate making predictions, estimates, and/or recommendations for subsequent data. Models may be created based upon example inputs in order to make valid and reliable predictions for novel inputs.

Additionally or alternatively, the machine learning programs may be trained and/or validated by inputting sample data sets or certain data into the programs, such as date data, vehicle make data, vehicle model data, vehicle year data, brand data of the current vehicle seat installed, product name data of the current vehicle seat installed, serial number data of the current seat installed, age data of the toddler and/or child, height data of the toddler and/or child, weight data of the toddler and/or child, etc. as well as known resulting data (e.g., a set of actually purchased and/or installed vehicle seats, and/or a set of actual time between vehicle seat recommendation requests and/or vehicle seat recommendations). The machine learning programs may utilize deep learning algorithms that may be primarily focused on pattern recognition and may be trained after processing multiple examples.

In supervised machine learning, a processing element may be provided with example inputs labeled with corresponding outputs, and the processing element may seek to discover a general association that maps inputs to outputs, so that when subsequent novel inputs are provided the processing element may, based upon the discovered association, accurately predict the correct output. In unsupervised machine learning, the processing element may be required to find and/or develop structure in unlabeled example inputs. In semi-supervised machine learning, the processing elements may use thousands of individual supervised machine learning iterations to generate a structure across the multiple inputs and outputs

By training a machine learning model in the disclosed manner, the trained machine learning model may be able to recommend vehicle seats most likely to be purchased and/or installed by the operator. This may result in a faster recommendation, selection, purchase, replacement, and/or installation of vehicle seats and/or reduce the amount of time needed to recommend, select, purchase, replace and/or install vehicle seats. In some instances, the recommendation of vehicle seats may be real time or near real-time.

### Exemplary Computing System

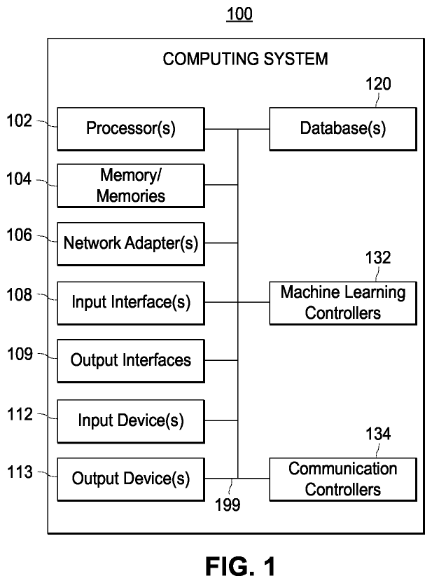

FIG. 1 depicts an exemplary computing system 100 to recommend one or more vehicle seats and/or predict the replacement time of one or more vehicle seats in accordance with described embodiments. The computing system 100 may include one or more processors 102, one or more memories 104, one or more network adapters 106, one or more input interfaces 108, and one or more output interfaces 109, one or more input devices 112, one or more output device 113, one or more databases 120, one or more machine learning controllers 132, and/or one or more communication controllers 134, all of which may be interconnected via a communication bus 199.

The one or more processors 102 may be, or may include, one or more central processing units (CPU), one or more coprocessors, one or more microprocessors, one or more graphical processing units (GPU), one or more digital signal processors (DSP), one or more application specific integrated circuits (ASIC), one or more programmable logic devices (PLD), one or more field-programmable gate arrays (FPGA), one or more field-programmable logic devices (FPLD), one or more microcontroller units (MCUs), one or more hardware accelerators, one or more special-purpose computer chips, and one or more system-on-a-chip (SoC) devices, etc.

The one or more memories 104 may be, or may include, any local short term memory (e.g., random access memory (RAM), read only memory (ROM), cache, etc.) and/or any long term memory (e.g., hard disk drives (HDD), solid state drives (SSD), etc.). The memories 104 may store computer-readable instructions configured to implement the methods described herein.

The one or more network adapters 106 may be, or may include, a wired network adapter, connector, interface, etc. (e.g., an Ethernet network connector, an asynchronous transfer mode (ATM) network connector, a digital subscriber line (DSL) modem, a cable modem) and/or a wireless network adapter, connector, interface, etc. (e.g., a Wi-Fi connector, a Bluetooth® connector, an infrared connector, a cellular connector, etc.) configured to communicate over a communication network.

The one or more input interfaces 108 may be, or may include, any number of different types of input units, input circuits, and/or input components that enable the one or more processors 102 to communicate with the one or more input devices 112. Similarly, the one or more output interfaces 109 may be, or may include, any number of different types of input units, input circuits, and/or input components that enable the one or more processors 102 to communicate the one or more output devices 113. In some embodiments, the one or more input interfaces 108 and the one or more output interfaces 109 may be combined into input/output (I/O) units, I/O circuits, and/or I/O components. The one or more input devices 112 may be, or may include, keyboards and/or keypads, interactive screens (e.g., touch screens), navigation devices (e.g., a mouse, a trackball, a capacitive touch pad, a joystick, etc.), microphones, buttons, communication interfaces, etc. The one or more output devices 113 may be, or may include display units (e.g., display screens, receipt printers, etc.), speakers, etc. The one or more input interfaces 108 and/or the one or more output interfaces 109 may also be, or may include digital applications (e.g., local graphical user interfaces (GUIs)).

The one or more databases 120 may be, or may include, one or more databases, data repositories, etc. For example, the one or more databases 120 may store the training data used to train a machine learning model described herein.

The one or more machine learning controllers 132 and/or the one or more communication controllers 134 may be, or may include, computer-readable, executable instructions that may be stored in the one or more memories 104 and/or performed by the one or more processors 102. The computer-readable, executable instructions of the one or more machine learning controllers 132 and/or the one or more communication controllers 134 may be stored on and/or performed by specifically designated hardware (e.g., micro controllers, microchips, etc.) which may have functionalities similar to the one or more memories 104 and/or the one or more processors 102. The computer-readable, executable instructions of the one or more machine learning controllers 132 may be configured to train, validate, and/or develop a machine learning model. The computer-readable, executable instructions of the one or more communication controllers 134 may be configured to send and/or receive electronic data. The one or more machine learning controllers 132 and/or the one or more communication controllers 134 may work independently and/or in conjunction with one another.

It should be appreciated that the computing system 100 should not be limited to the components described above, and that additional and/or alternative components are contemplated.

### Exemplary Machine Learning Environments

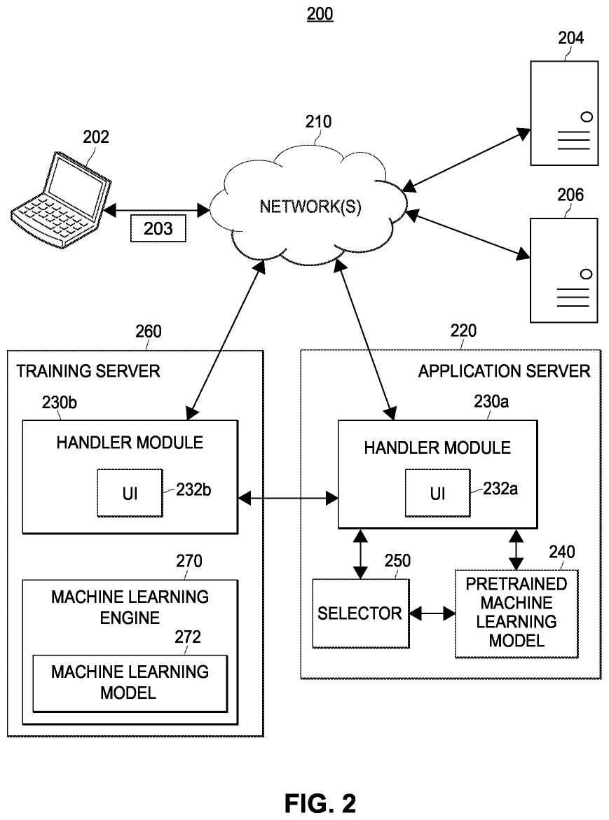

FIG. 2 depicts an exemplary computing environment 200. The exemplary computing environment 200 may include a user device 202, an initial request 203, one or more seat manufacturer databases 204, one or more vehicle manufacturer databases 206, one or more networks 210, an application server 220, and/or a training server 260.

The user device 202 may be, or may include, a computing device such as a laptop computer, a tablet, a smartphone, a desktop device, a wearable device, mobile device, smart contacts, smart glasses, augmented reality glasses, virtual reality headset, etc. The initial request 203 may be, or may include, any sort of electric message, notification, indication, etc.

The one or more seat manufacturer databases 204 and/or the one or more vehicle manufacturer databases 206 may be, or may include, one or more databases, servers, data repositories, etc.

The one or more networks 210 may be, or may include, the internet, a local area network (LAN), a metropolitan area network (MAN), a wide area network (WAN), a wired network, a Wi-Fi network, a cellular network, a wireless network, a private network, a virtual private network, etc.

The application server 220 may include a handler module 230a, the pretrained machine learning model 240, and/or the selector 250. The handler module 230a may include UI 232a. The application server 220 may be, or may include, a portion of a memory unit (e.g., the one or more memories 104 of FIG. 1) configured to store software and/or computer-executable instructions that, when executed by a processing unit (e.g., the one or more processors 102 of FIG. 1), may cause the one or more of the aforementioned components to recommend one or more vehicle seats and/or predict a replacement time for one or more vehicle seats.

The training server 260 may include a handler module 230b and/or a machine learning engine 270. The handler module 230b may include UI 232b. The machine learning engine 270 may develop and/or store a machine learning model 272. The training server 260 may be, or may include, a portion of a memory unit configured to store software and/or computer-executable instructions that, when executed by a processing unit, may train, validate, and/or otherwise develop the machine learning model 272 for recommending one or more vehicle seats and/or predicting a replacement time for one or more vehicle seats. In some embodiments, application server 220 and the training server 260 may be the same server.

In operation, the training server 260 train, validate, and/or otherwise develop the machine learning model 272 based upon one or more sets of training image data. The machine learning model 272 may be a binary classification model, such as a CNN, a logistic regression model, a naïve Bayes model, a support vector machine (SVM) model, and/or the like. Regardless of the type of binary classification model, the binary classifications may be either “likely to be purchased” and/or “likely to be installed” as a first classification and “not likely to be purchased” and/or “not likely to be installed” as a second classification.

Once the training server 260 initially trains and/or initially develops the machine learning model 272, the training server 260 may then validate the machine learning model 272. In some embodiments, the training server 260 segments out a set of validation data may be from the corpus of training data to use when validating model performance. In these embodiments, the training data is divided into a ratio of training data and validation data (e.g., 80% training data and 20% validation data). When the machine learning model 272 satisfies a validation metric (e.g., accuracy, recall, area under curve (AUC), etc.) when applied to the validation data, the machine learning model 272 may be implemented as the pretrained machine learning model 240 used by the application server 220. However, if the machine learning model 272 does not satisfy the validation metrics, the training server 260 may continue training the machine vision model 272 using additional training data.

In operation, the application server 220 may connect to the user device 202 and/or one or more databases, servers, and/or other data repositories (e.g., one or more seat manufacturer databases 204, one or more vehicle manufacturer databases 206, etc.) via one or more networks 210. In some embodiments, the connection may include a user of the user device 202 signing into an account stored with the application server 220. In some embodiments, the connection may include navigating to a website and/or a web application hosted by the application server 220. In some embodiments, the connection may include the user device 202, as a client, establish a client-host connection to the application server 220, as a host. In these embodiments, the user device 202 may establish the client-host connection via an application run on the user device 202. In some embodiments, the connection may be through either a third party connection (e.g., an email server) or a direct peer-to-peer (P2P) connection/transmission.

The application server 220 may route one or more sets of input data (e.g., from the initial request 203) received over the one or more networks 210 to the handler module 230a. The input data may be vehicle data, child and/or toddler data, location data, vehicle interior parameters, vehicle seat parameters, date data, vehicle seat data, and/or other data. The handler module 230a may forward the one or more sets of input data to pretrained machine learning model 240, which may output a determination as to whether a vehicle seat list likely to be purchased and/or installed or a prediction as to whether a vehicle seat is likely to be replaced. The resulting determination may be returned to the handler module 230a which may in turn present the resulting determination to the user via the user device 202.

In some embodiments, the handler module 230a may implement an interactive UI 232a (e.g., a web-based interface, mobile application, etc.) that may be presented by the user device 202. In particular, the interactive UI 232a may be configured to enable the user to submit the input data.

In some embodiments, more than one vehicle seat may be selected and/or recommended. In these embodiments, a ranking system may be utilized to rate each of the potential vehicle seat candidates. As such, the resulting list of recommended vehicle seats from the pretrained machine learning model 240 may be ranked by a selector 250. The selector 250 may sort the list of recommended vehicle seats by their rank in addition to removing vehicle seats from the list if their rank does not exceed and/or meet a threshold amount. In these embodiments, this ranked list of recommended vehicle seats may be passed to the handle module 230a and subsequently presented to the user via the user device 202.

In some additional and/or alternative embodiments, the handler module 230a may purchase vehicle seats on the user's behalf based upon a vehicle seat selected from the one or more recommended vehicle seats as well as the information submitted by the user with the request (e.g., the user's identity data, location data, etc.). In these embodiments, the application server 220 identifies one or more stores that sells vehicle seats and the locations of the one or more stores. The application server 220 may check the stock of the one or more stores to determine if the one or more stores sells the one or more recommended vehicle seats. The application server 220 may sort the one or more stores that sell the one or more recommended vehicle seats in order of closest distance to the location of the user (e.g., based upon input location data). The handler module 230a may present the one or more stores and/or the subset of recommended vehicle seats sold by the one or more stores to the user. Upon the user's selection, the application server 220 may connect to the selected store (e.g., via the one or more networks 210) to purchase and/or otherwise order the recommended vehicle seat on the user's behalf (e.g., by using the user's input data included with the initial request 203 and/or a prior request). In some additional or alternative embodiments, the application server 220 may provide a link for the user to connect to the selected store (e.g., the listing page of the selected vehicle seat on a website hosted on a server of the selected store) to allow the user to purchase and/or otherwise order the selected vehicle seat.

In some additional or alternative embodiments, upon predicting the replacement time of a vehicle seat, the application server 220 may perform a vehicle seat recommendation based upon the data of the prior request in addition to any determined data (e.g., the child's currently estimated height and/or weight, etc.). The application server 220 may present the results of the vehicle seat recommendation to the user device 202 directly via the handler module 230a.

It should be appreciated that while specific elements, processes, devices, and/or components are described as part of the application server 220, other elements, processes, devices and/or components are contemplated.

### Exemplary Input Vectors

An example input vector may include input data such as a vehicle data set (e.g., a vehicle year, a vehicle make, a vehicle model, etc.), a current seat data set (e.g., a seat brand, a seat product name, a seat serial number, etc.), a child and/or toddler data set (e.g., an age of the child and/or toddler, a height of the child and/or toddler, a weight of the child and/or toddler, etc.), a location data set (e.g., a geolocation, an address, a zip code, etc.), one or more vehicle interior parameters (e.g., one or more dimensions of the vehicle's interior, one or more dimensions of the seat area of the vehicle such as height, length, and/or depth, etc.), one or more seat parameters (e.g., dimensions of the vehicle seat such as height, length, and/or depth, weight limit of the seat, etc.), a date data set (e.g., time, a day, a date, a year, a month, a season, etc.), a seat data set (e.g., information of manufactures of vehicle seats, listing of vehicle seat manufacturers, listing of vehicle seats available to purchase, dimensions of vehicle seats available for purchase, weight limit of vehicle seats available for purchase, etc.), and/or other data (e.g., reviews of seats available for purchase, price of vehicle seats available for purchase, installation of vehicle seats, product information of vehicle seats available for purchase, list of stores selling vehicle seats, location of stores selling vehicle seats, list of stores selling vehicle seats near the requestor, information of stores selling vehicle seats, in stock information of vehicle seats in the list of stores, etc.). Any of the foregoing example input data may be submitted by a user as user entered data, determined by the computing system 100 and/or the computing environment 200 as determined data, and/or pulled by the computing system 100 and/or the computing environment 200 from one or more databases, servers, and/or other data repositories (e.g., the one or more seat manufacturer databases 204, the one or more vehicle manufacturer databases 206, etc.) over one or more networks as pulled data.

The user entered data may be included with an initial request 203 for a seat recommendation and/or a prior request for a vehicle seat recommendation. Additionally or alternatively, the user entered data may be included separately from the initial request 203 and/or prior request and be submitted by the user either before, subsequent to, and/or after the initial request 203 and/or prior request. In some embodiments, the user may submit the initial request 203 and/or the user entered data by a user device 202 connected to the application server 220 via the one or more networks 210. The initial request 203 and/or the user entered data may be generated and/or submitted to the application server 220 via a website, a web application, a user device 202 application, an electronic communication (e.g., email, electronically transmitted documents, etc.), and/or the like.

The computing system 100 and/or the computing environment 200 may determine any of the aforementioned data and/or any other data based upon preexisting data. For example, the computing system 100 and/or the computing environment 200 may calculate the weight limit of a vehicle seat based upon the dimensions of the vehicle seat. As another example, the computing system 100 and/or the computing environment 200 may determine the dimensions of the vehicle seat that are needed to properly install the vehicle seat into the vehicle based upon the dimensions of the seat area of the vehicle. As yet another example, the computing system 100 and/or the computing environment 200 may calculate the height of the child and/or toddler and/or the weight of the child and/or toddler based upon a prior height and/or weight of the child and/or toddler (e.g., obtained from a prior vehicle seat recommendation request) and/or a determined growth rate of the child and/or toddler (which may also be calculated based upon the prior heights and/or weights of the child and/or the average growth rate of children and/or toddlers with similar ages in similar locations).

The computing system 100 and/or the computing environment 200 may pull any of the aforementioned data and/or any other data from one or more databases and/or other data repositories stored across one or more networks 210.

Any of the foregoing input data may include one or more fields, labels, entries, parameters, and/or values in addition to, interchanged with, and/or instead of those listed.

### Exemplary Machine Learning Training Module

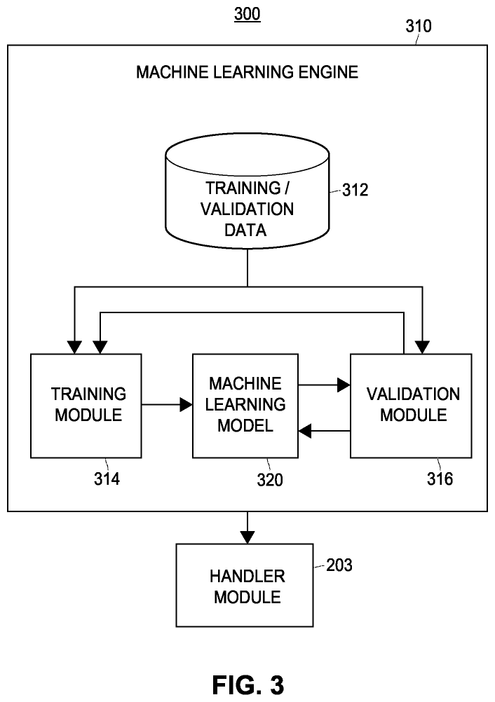

FIG. 3 depicts an exemplary machine learning training module 300. The machine learning training module 300 may include a machine learning engine 310 (e.g., the machine learning engine 270). The machine learning engine 310 may include training and/or validation data 312, a training module 314 and/or a validation module 316.

The machine learning engine 310 may be, or may include, a portion of a memory unit (e.g., the one or more memories 104) configured to store software and/or computer-executable instructions that, when executed by a processing unit (e.g., the one or more processors 102), may cause the one or more of the above-described components to generate, develop, train, validate, and/or deploy a machine learning model 320 (e.g., the machine learning model 272) for recommending a vehicle seat and/or predicting the replacement time of a vehicle seat. The trained machine learning model 320 may be implemented as the pretrained machine learning model (e.g., the pretrained machine learning model 240) used by an application server (e.g., the application server 220). In some embodiments, the machine learning training module 300 trains multiple machine learning models 320.

The training and/or validation data 312 may include labeled training data detailing previously entered input data, previously recommended vehicle seats, and/or corresponding designations of whether the requestor actually purchased and/or installed the recommended vehicle seat. The machine learning engine 310 may pass the training and/or validation data 312 to the training module 314 and/or the validation module 316. In some embodiments, the machine learning engine 310 segments out a portion of the training data to be a validation set. For example, the machine learning engine 310 may segment out 20%, 10%, 5%, etc., of the training data for the validation data set.

The training model 314 may utilize one or more machine learning techniques to train the machine learning model 320. In some embodiments, the machine learning model 320 is a CNN, a FCN, or another type of neural network. Accordingly, the training process may include analyzing the labels applied to the training data to determine a plurality of weights associated with the various layers of the neural network.

The validation module 316 may validate the resulting machine learning model 320 by determining a validation metric rate (e.g., accuracy, precision, recall, etc.) of the machine learning model 320. If the validation metric of the machine learning model 320 does not meet a predetermined threshold value, the validation module 316 may instruct the training module 314 to continue training the machine learning model 320 until the machine learning model 320 satisfies the validation metric.

Once the machine learning vision model 320 satisfies the validation metric, the machine learning engine 310 may pass the resulting machine learning model 320 to the handler module 230 (e.g., the handler module 230b) of a training server (e.g., the training server 160), which, in turn, may pass the machine learning model 320 to another handler module 230 (e.g., the handler module 230a) of the application server to be implemented as the pretrained machine learning model.

The machine learning model 320 may be developed, trained, and/or validated from multiple, parallel machine learning engines 310. It should be appreciated that while specific elements, processes, devices, and/or components are described as part of example machine learning training module 300, other elements, processes, devices and/or components are contemplated and/or the elements, processes, devices, and/or components may interact in different ways and/or in differing orders, etc.

### Exemplary Implementation of the Vehicle Seat Recommendation System

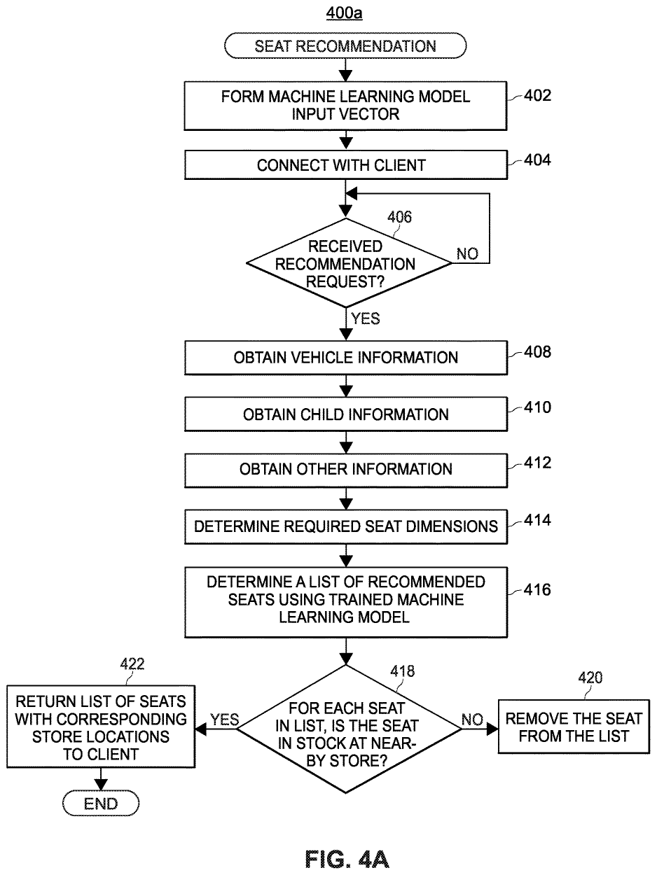

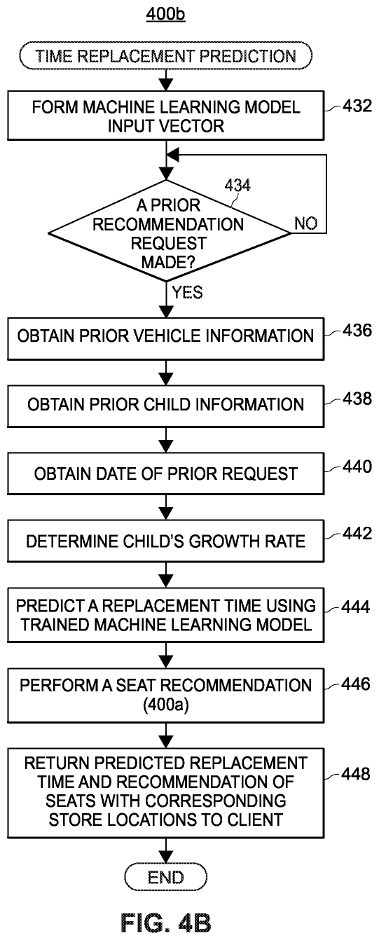

FIG. 4A depicts an exemplary computer-based method 400a for implementing vehicle seat recommendations, according to some aspects. In some aspects, the method 400a may correspond to, and/or be implemented by, the application server 220 of FIG. 2.

The processes, methods, software, and/or computer-executable instructions included within the method 400a may be, or may include, an executable program or portion of an executable program for execution by a processor such as the one or more processors 102 of FIG. 1. The program may be embodied in software or instructions stored on a non-transitory computer-readable storage medium or disk associated with the one or more processor 102. Further, although the example program is described with reference to the flowchart illustrated in FIG. 4A, many other methods of implementing the application server 220 may alternatively be used. For example, the order of execution of the blocks may be changed, and/or some of the blocks described may be changed, eliminated, or combined.

Additionally, or alternatively, any or all of the blocks may be implemented by one or more hardware circuits (e.g., discrete and/or integrated analog and/or digital circuitry, an application specific integrated circuit (ASIC), a programmable logic device (PLD), a field programmable gate array (FPGA), a field programmable logic device (FPLD), a logic circuit, etc.) structured to perform the corresponding operation without executing software or firmware.

The method 400a of FIG. 4A may begin by using one or more sets of input data (e.g., vehicle data, current seat data, child and/or toddler data, location data, date data, vehicle interior parameters, seat parameters, seat data, and/or other data) to form an input vector (block 402). A vehicle seat recommendation system (e.g., application server 220) may use the input vector develop a machine learning model to recommend one or more vehicle seats via a machine learning training module 300.

The vehicle seat recommendation system may connect to a client device (e.g., a user device 202) (block 404) via a website, a web application, a client device application, and/or the like over one or more networks 210. Alternatively, the vehicle seat recommendation system may connect to a predictive replacement time system. The vehicle seat recommendation system may wait until the vehicle seat recommendation system receives a vehicle seat recommendation request. The vehicle seat recommendation request may be an electronic message (e.g., an email, a transmission of electronic documents, etc.), an electronic signal sent by the user device 202 (e.g., via the selection of an interactive element—such as a “Submit Request” interactive button —on a UI of a website, web application, etc.), an electronic form containing one or more data entries filled by the user transmitted by the user device 202, and/or the like.

If the vehicle seat recommendation system has not received a vehicle seat recommendation request (block 406), the method 400a may return back to the start of block 406 until it receives a vehicle seat request. If the vehicle seat recommendation system has received a vehicle seat recommendation request (block 406), the vehicle seat recommendation system may receive vehicle information (e.g., vehicle data) (block 408), child and/or toddler information (e.g., child and/or toddler data) (block 410), and/or other information (e.g., current seat data, location data, vehicle interior parameters, seat parameters, date data, seat data, and/or other data) (block 412).

The vehicle seat recommendation system may determine the necessary dimensions and/or weight limit of potential vehicle seat candidates based upon the entered and/or determined height and/or weight of the child and/or toddler (block 414). For example, upon receiving, determining, or otherwise obtaining the height, and/or weight of the child and/or toddler, the vehicle seat recommendation system may limit the pool of potential vehicle seat candidates based upon vehicle seat dimensions and/or vehicle seat weight limits corresponding to the height and/or weight of the child and/or toddler. In the cases where the dimensions and/or weight limits of the potential vehicle seat candidates are not immediately accessible and/or readily knowable, the vehicle seat recommendation system may calculate the dimensions of the potential vehicle seat candidates (e.g., based upon images of the vehicle seats) and/or the weight limit of the potential vehicle seat candidates (e.g., based upon the dimensions of the vehicle seat). Additionally or alternatively, vehicle seats without immediately accessible and/or readily knowable dimensions and/or weight limits may be removed from the pool of potential vehicle seat candidate. In this way, the vehicle seat recommendation system may limit the potential vehicle seat candidates to those that may safely sit designated children and/or toddlers.

The vehicle seat recommendation system may pass the input data included with the vehicle seat recommendation request through the fully developed machine learning model (e.g., the machine learning model 320) to generate one or more vehicle seat recommendations (block 416). The recommended vehicle seats may include seat brand information, seat product name information, seat serial numbers, images of the vehicle seats etc. all of which may be presented to the user via the user device 202. In the embodiments where multiple vehicle seats are recommended, the vehicle seat recommendation system may rank the plurality of vehicle seats based upon a “best fit” model (e.g., the vehicle seats with a higher rank may have (1) higher customer review scores, (2) lower price, (3) may accommodate a larger range of body sizes, (4) may be more widely available, etc.) to sort the plurality of vehicle seats into a resulting list. The vehicle seat recommendation system may then present the resulting list to the user. In the embodiments where a single vehicle seat is recommended, the vehicle seat recommendation system may also rank the vehicle seat candidates according to a “best fit” model, but vehicle seat recommendation system may only select and/or present the vehicle seat that ranks the highest.

The vehicle seat recommendation system may search for one or more stores selling vehicle seats near the user's location. If the one or more identified stores does not sell a vehicle seat from the resulting one or more vehicle seats recommended (block 418), the vehicle seat recommendation system may remove the vehicle seat from the list of vehicle seat recommendations (block 420), and the method 400a may return back to the start of block 418 until all recommended vehicle seats have been determined to be either in stock or not in stock for each of the one or more identified stores. If the one or more identified stores does sell a vehicle seat from the resulting one or more vehicle seats recommended (block 418), the vehicle seat recommendation system may present the resulting one or more vehicle seats and/or the one or more stores to the user (block 422).

The user may select one or more vehicle seats from the one or more vehicle seat recommendations and direct the vehicle seat recommendation system to purchase and/or otherwise order the one or more vehicle seats on the user's behalf from the one or more stores. The user may also select which of the one or more stores the vehicle seat recommendation system purchases and/or otherwise orders the one or more vehicles from. The method 400a may exit.

### Exemplary Implementation of the Predictive Replacement Time System

FIG. 4B depicts an exemplary computer-based method 400b for implementing predictions of replacement time of vehicle seats, according to some aspects. In some aspects, the method 400b may correspond to, and/or be implemented by, the application server 220 of FIG. 2.

The processes, methods, software, and/or computer-executable instructions included within the method 400b may be, or may include, an executable program or portion of an executable program for execution by a processor such as the one or more processors 102 of FIG. 1. The program may be embodied in software or instructions stored on a non-transitory computer-readable storage medium or disk associated with the one or more processor 102. Further, although the example program is described with reference to the flowchart illustrated in FIG. 4B, many other methods of implementing the application server 220 may alternatively be used. For example, the order of execution of the blocks may be changed, and/or some of the blocks described may be changed, eliminated, or combined.

Additionally, or alternatively, any or all of the blocks may be implemented by one or more hardware circuits (e.g., discrete and/or integrated analog and/or digital circuitry, an application specific integrated circuit (ASIC), a programmable logic device (PLD), a field programmable gate array (FPGA), a field programmable logic device (FPLD), a logic circuit, etc.) structured to perform the corresponding operation without executing software or firmware.

The method 400b of FIG. 4B may begin by using one or more sets of input data (e.g., vehicle data, current seat data, child and/or toddler data, location data, date data, vehicle interior parameters, seat parameters, seat data, and/or other data) to form an input vector (block 432). A predictive replacement time system (e.g., application server 220) may use the input vector develop a machine learning model to predict the replacement time of one or more vehicle seats via a machine learning training module 300.

The predictive replacement time system may wait until the predictive replacement time system receives a request for a prediction of a replacement time for one or more vehicle seats. The request may be a triggered event that may occur after a predetermined amount of time has passed (e.g., 6 months, 1 year, etc.). If the predictive replacement time system has not received a request for a prediction of a replacement time (block 434), the method 400b may return back to the start of block 434 until it receives a request for a prediction of a replacement time. If the predictive replacement time system has received a request for a prediction of a replacement time (block 434), the predictive replacement time system may receive vehicle information (e.g., vehicle data) (block 436), child and/or toddler information (e.g., child and/or toddler data) (block 438), date information on a prior vehicle seat recommendation request and/or vehicle seat recommendation (block 440), and/or other information (e.g., current seat data, location data, vehicle interior parameters, seat parameters, date data, seat data, and/or other data) (not shown).

The predictive replacement time system may determine the growth rate of the toddler and/or child based upon the prior age, height, and/or weight of the child and/or toddler from previous vehicle seat recommend requests, previous vehicle seat recommendations, and/or previous predictions of replacement times of vehicle seats (block 442). For example, the growth rate may be determined from general growth patterns in the user's local population when compared to the prior data of the child and/or the child's current age. Additionally or alternatively, the growth rate may be generated by the child's previous height and/or weight (thus creating a rate of change plot) if more than one vehicle seat recommendation requests were made by the user and/or more than one vehicle seat recommendations were made by the vehicle seat recommendation system. In this instance, the predictive replacement time system calculates the growth-rate of the child and/or toddler from the prior ages, heights, and/or weights, at the time the corresponding requests were submitted and/or vehicle seat recommendations were generated. In this way, the predictive replacement time system may estimate the current height and/or weight of the child and/or toddler based upon their calculated current age.

The predictive replacement time system may pass the input data included with prior vehicle seat recommendation requests and/or prior vehicle seat recommendations through the fully developed machine learning model (e.g., the machine learning model 320) to predict the replacement time of one or more vehicle seats (block 444). The predicted replacement time may include date and/or time data, both of which may be presented to the user via the user device 202 a set time before the predicted replacement time has passed (e.g., one week before, one month before, etc.).

The predictive replacement time system may execute the method 400a of FIG. 4A to recommend one or more vehicle seats for the replacement of the currently installed vehicle seat (block 446). The vehicle seat recommendation system and/or the predictive replacement time system may return the resulting one or more vehicle seat recommendations and/or predictions of replacement time of one or more vehicle seats to the user (block 448). The recommended vehicle seats may include seat brand information, seat product name information, seat serial numbers, images of the vehicle seats etc. all of which may be presented to the user via the user device 202. In the embodiments where multiple vehicle seats are recommended, the vehicle seat recommendation system may rank the plurality of vehicle seats based upon a “best fit” model (e.g., the vehicle seats with a higher rank may have (1) higher customer review scores, (2) lower price, (3) may accommodate a larger range of body sizes, (4) may be more widely available, etc.) to sort the plurality of vehicle seats into a resulting list. The vehicle seat recommendation system may then present the resulting list to the user. In the embodiments where a single vehicle seat is recommended, the vehicle seat recommendation system may also rank the vehicle seat candidates according to a “best fit” model, but the vehicle seat recommendation system may only select and/or present the vehicle seat that ranks the highest.

The user may select one or more vehicle seats from the one or more vehicle seat recommendations and direct the predictive replacement time system to purchase and/or otherwise order the one or more vehicle seats on the user's behalf from one or more stores selling the one or more vehicle seats. The user may also select which of the one or more stores the predictive replacement time system purchases and/or otherwise orders the one or more vehicles from. The method 400b may exit.

### Exemplary Implementation of the Machine Learning Training Module

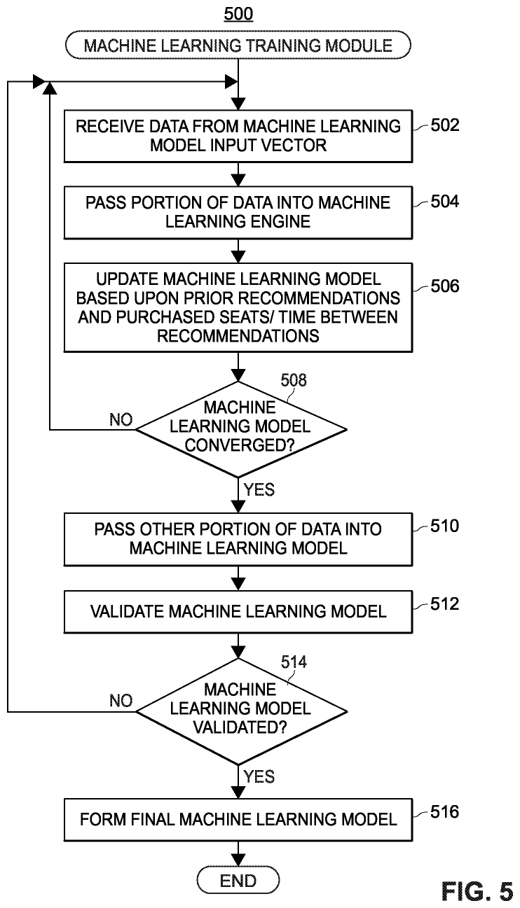

FIG. 5 depicts an exemplary computer-based method 500 for implementing the machine learning training module 300, according to some aspects. In some aspects, the method 500 may correspond to, and/or be implemented by, the machine learning engine 310 and/or the machine learning model 320of FIG. 3.

The processes, methods, software, and/or computer-executable instructions included within the method 500 may be, or may include, an executable program or portion of an executable program for execution by a processor such as the one or more processors 102 of FIG. 1. The program may be embodied in software or instructions stored on a non-transitory computer-readable storage medium or disk associated with the one or more processor 102. Further, although the example program is described with reference to the flowchart illustrated in FIG. 5, many other methods of implementing the machine learning training module 300 may alternatively be used. For example, the order of execution of the blocks may be changed, and/or some of the blocks described may be changed, eliminated, or combined.

Additionally, or alternatively, any or all of the blocks may be implemented by one or more hardware circuits (e.g., discrete and/or integrated analog and/or digital circuitry, an application specific integrated circuit (ASIC), a programmable logic device (PLD), a field programmable gate array (FPGA), a field programmable logic device (FPLD), a logic circuit, etc.) structured to perform the corresponding operation without executing software or firmware.

The method 500 of FIG. 5 may begin when a vehicle seat recommendation system and/or a predictive replacement time system receives, accesses, and/or otherwise obtains data to form an input vector (e.g., from a database storing training and/or validation data 312) (block 502). The method 500 may pass a portion of the data through the training module 314 (block 504). The method 500 may develop the machine learning model within the training module 314 by updating the machine learning model 320 based upon comparisons between the outputs of the machine learning model 320 and the designations applied to the training and/or validation data 312 (i.e., the data of the prior requests and/or recommendations against the actually purchased and/or installed vehicle seats and/or the actual time between vehicle seat requests) (block 506).

If training of the machine learning model 320 has not converged (block 508), the method 500 may return back to the start of the process to obtain more data (via block 502) and redevelop the machine learning model (via blocks 504 and 506) to continue training and developing the machine learning model 320. If training of the machine learning model 320 has converged (block 508), the remaining portion of the data may be passed through the developing machine learning model 320 (block 510) and the validation module 316 to validate the machine learning model 320 (block 512).

If the validation module 316 validates the machine learning model 320 (block 514), the machine learning model 320 may become the pretrained machine learning model 240 (block 516) that may be applied to future instances the model has not yet seen, and the method 500 may exit from the method of FIG. 5. If the validation module 316 does not validate the machine learning model 320 (block 514), the method 500 may return back to the start of the method 500.

### Exemplary User Interfaces

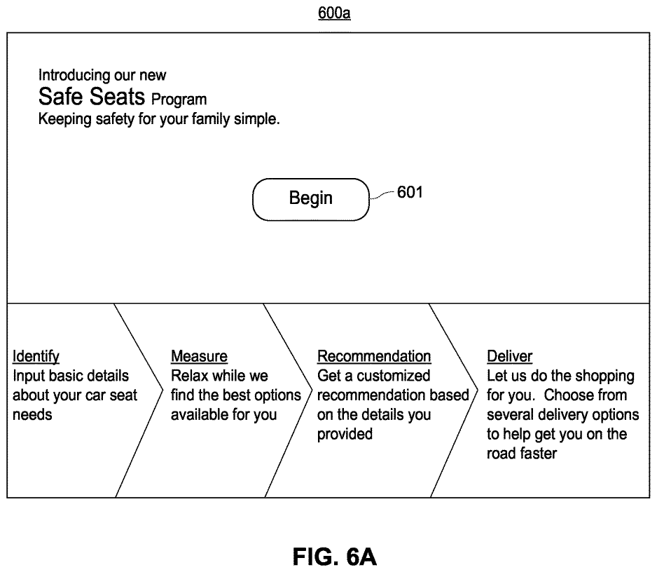

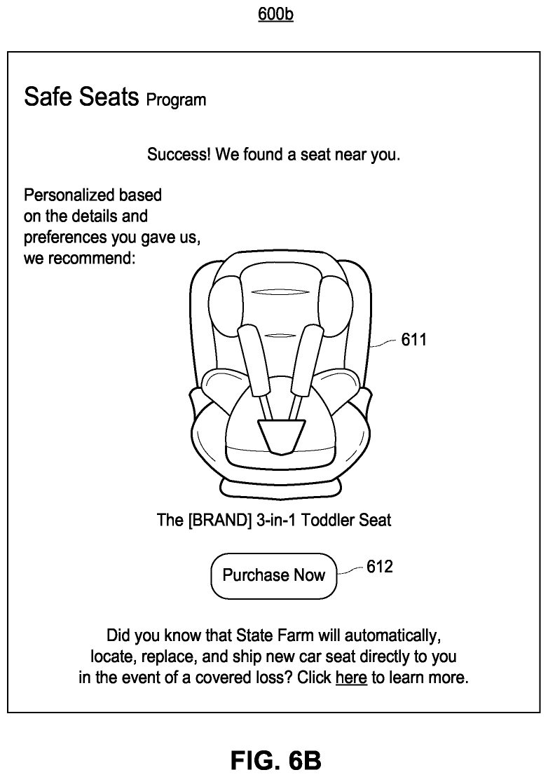

FIGS. 6A and 6B depict exemplary interactive user interfaces (UI) 600a and 600b, respectfully. The interactive UIs 600a and 600b may be implemented and executed on the user's client device (e.g., the user device 202). In some embodiments, the interactive UIs 600a and 600b may be displayed on a client device (e.g., the user device 202). The interactive UIs 600a and 600b may display in response to the execution of one or more instructions (e.g., a web application, a device application, etc.). The one or more instructions may be executed by the client device, the vehicle seat recommendation system and/or predictive replacement time system (e.g., the application server 220), and/or a combination thereof (e.g., via a website executing on a server with an output display being rendered by the client device).

FIG. 6A depicts interactive UI 600a for user to place vehicle seat recommendation requests with the vehicle seat recommendation system. The interactive UI 600a may have an interactive UI element 601 to initiate the vehicle seat recommendation system. The interactive UI 600a may also have interactive fields (not shown) for user to input data (e.g., user entered data as described herein).

FIG. 6B depicts interactive UI 600b for the vehicle seat recommendation system to display resulting vehicle seat recommendations to the user. The interactive UI 600b may display one or more vehicle seat recommendations 611 to the user. The interactive UI 600b may also have an interactive UI element 612 to cause the vehicle seat recommendation system to purchase the displayed one or more vehicle seat recommendations on the user's behalf.

It should be appreciated that the UIs 600a and/or 600b are exemplary in nature and additional and/or alternative features, elements, and/or implementations of the UIs are contemplated.

### Exemplary Method of Recommending Vehicle Seats

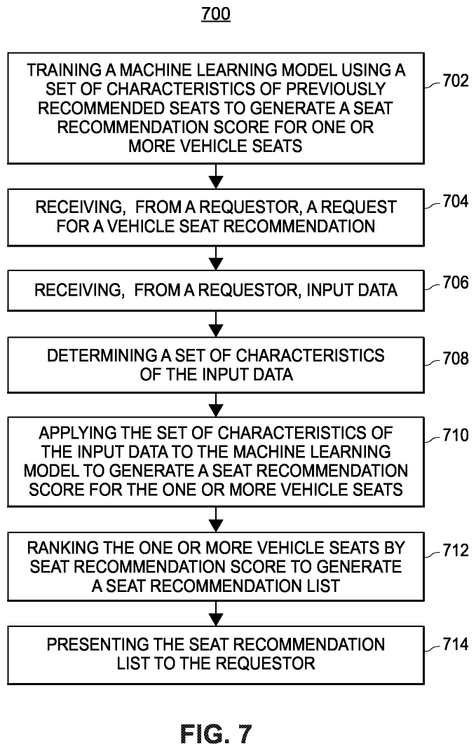

FIG. 7 depicts an exemplary computer-implemented method 700 for recommending a vehicle seat. The method 700 depicted in FIG. 7 may employ any of the techniques, methods, and systems described herein with respect to FIGS. 1-6B.

The method 700 may begin at block 702 by training, by the one or more processors, a machine learning model using a set of characteristics of previously recommended seats to generate a seat recommendation score for one or more vehicle seats.

A machine learning engine (e.g., machine learning engine 270 and/or machine learning engine 310) may generate a machine learning model based upon training data from previously recommended vehicle seats. The training data may include, for each previously recommended vehicle seat, a set of characteristics of the previously recommended vehicle seat and an actually purchased and/or installed vehicle seats for the previously recommended vehicle seat.

The machine learning engine may validate the machine learning model generated. In some embodiments, the validation may be conducted using the machine learning technique used to generate the model. Further, in some embodiments, the validation data may be from the same collection of data as the training data. In these embodiments, the training data is divided into a ratio of training data and validation data (e.g., 80% training data and 20% validation data). The machine learning engine uses the training data to generate the machine learning model and the machine learning engine uses the validation data to determine the accuracy of the model. When the machine learning engine is correct more than a predetermined threshold amount, the pretrained machine learning model may be used for recommending vehicle seats and/or predicting replacement times of vehicle seats. However, if the machine learning model is not correct more than the threshold amount, the machine learning model may continue obtaining sets of training data and/or validation data for further training and/or validation.

The method 700 may proceed to block 704 by receiving, by one or more processors (e.g., via the handler module 230a) from a requestor, a request for a vehicle seat recommendation.

In some embodiments, a vehicle seat recommendation system (e.g., the application server) may receive the request from a predictive replacement time system (e.g., the application server). The request may include input data.

The method 700 may proceed to block 706 by receiving, by the one or more processors from the requestor, input data.

The input data may include vehicle data (e.g., vehicle year, vehicle make, vehicle model, etc.), current seat data (e.g., seat brand, seat product name, seat serial number, etc.), child and/or toddler data (e.g., age, height, weight, etc.), location data (e.g., geolocation, address, zip code, etc.), date data (e.g., time, day, date, year, month, season, etc.), vehicle interior parameters (e.g., dimensions of the vehicle's interior, dimensions of the seat area for installation of the vehicle such as height, length, and/or depth, etc.), seat parameters (e.g., dimensions of the vehicle seat such as height, length, and/or depth, weight limit of the seat, etc.), seat data (e.g., information of manufactures of vehicle seats, listing of vehicle seat manufacturers, listing of vehicle seats available to purchase, dimensions of vehicle seats available for purchase, weight limit of vehicle seats available for purchase, etc.), and/or other data (e.g., price of vehicle seats available for purchase, reviews of seats available for purchase, list of stores selling vehicle seats, information of stores selling vehicle seats, location of stores selling vehicle seats, product information of vehicle seats available for purchase, reviews of vehicle seats available for purchase, etc.). Any of the foregoing input data may be submitted by the requestor, determined by the vehicle seat recommendation system, and/or pulled by the vehicle seat recommendation system over one or more networks.

The method 700 may proceed to block 708 by determining, by the one or more processors, a set of characteristics of the input data.

The set of characteristics may include classifications, categories, fields, entries, parameters, values, interconnected data, etc. related to and/or derived from prior input data (e.g., user entered data, determined data, and/or pulled data).

The method 700 may proceed to block 710 by applying, by the one or more processors, the set of characteristics of the input data to the machine learning model to generate a seat recommendation score for the one or more vehicle seats.

The method 700 may proceed to block 712 by ranking, by the one or more processors, the one or more vehicle seats by seat recommendation score to generate a seat recommendation list.

In these embodiments, the vehicle seat recommendation system may rank the one or more vehicle seats based upon a “best fit” model (e.g., the vehicle seats with a higher rank may have (1) higher customer review scores, (2) lower price, (3) may accommodate a larger range of body sizes, (4) may be more widely available, etc.) to sort the resulting vehicle seat recommendation list. The vehicle seat recommendation system may then present the resulting list to the user. Additionally or alternatively, the vehicle seat recommendation system may not generate a list and may present all the resulting outputs to the user. Additionally or alternatively, the vehicle seat recommendation system may instead select a single vehicle seat and present that to the user as a resulting output. In these embodiments, the vehicle seat recommendation system may also rank the one or more vehicle seat candidates according to a “best fit” model, but vehicle seat recommendation system may only select and/or present the single vehicle seat that ranks the highest.

The method 700 may proceed to block 714 by presenting, by the one or more processors, the seat recommendation list to the requestor. The user may select one or more vehicle seats from the seat recommendation list via the user device 202.

### Exemplary Method of Estimating When a Vehicle Seat Should be Replaced

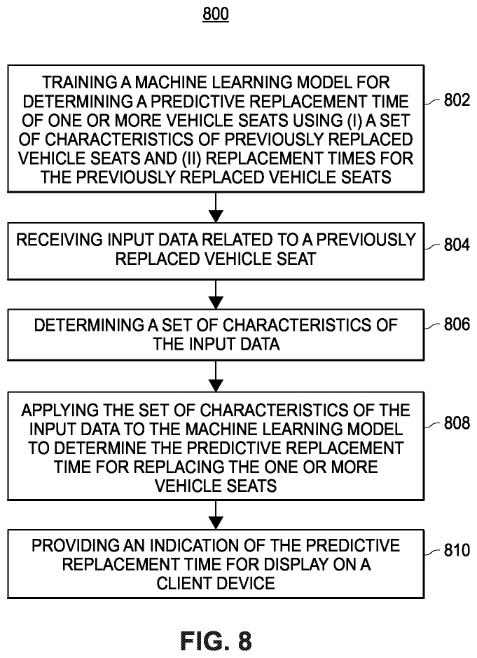

FIG. 8 depicts an exemplary computer-implemented method 800 for predicting the replacement time of a vehicle seat. The method 800 depicted in FIG. 8 may employ any of the machine learning techniques, methods, and systems described herein with respect to FIGS. 1-7.

The method 800 may begin at block 802 by training, by one or more processors, a machine learning model for determining a predictive replacement time of one or more vehicle seats using (i) a set of characteristics of a previously recommended vehicle seat and (ii) replacement times for the previously recommended vehicle seat.

A machine learning engine (e.g., machine learning engine 270 and/or machine learning engine 310) may generate a machine learning model based upon training data from previously recommended vehicle seats. The training data may include, for each previously recommended vehicle seat, a set of characteristics of the previously recommended vehicle seat and a time duration between the previous vehicle seat recommendation requests and/or the previously recommended vehicle seats.

The machine learning engine may validate the machine learning model generated. In some embodiments, the validation may be conducted using the machine learning technique used to generate the model. Further, in some embodiments, the validation data may be from the same collection of data as the training data. In these embodiments, the training data is divided into a ratio of training data and validation data (e.g., 80% training data and 20% validation data). The machine learning engine uses the training data to generate the machine learning model and the machine learning engine uses the validation data to determine the accuracy of the model. When the machine learning engine is correct more than a predetermined threshold amount, the machine learning model may be used for recommending vehicle seats and/or predicting replacement times of vehicle seats. However, if the machine learning model is not correct more than the threshold amount, the machine learning model may continue obtaining sets of training data and/or validation data for further training and/or validation.

The method 800 may proceed to block 804 by receiving, by the one or more processors, input data related to a previously recommended vehicle seat.

The input data may include vehicle data (e.g., vehicle year, vehicle make, vehicle model, etc.), current seat data (e.g., seat brand, seat product name, seat serial number, etc.), child and/or toddler data (e.g., age, height, weight, etc.), location data (e.g., geolocation, address, zip code, etc.), date data (e.g., time, day, date, year, month, season, etc.), vehicle interior parameters (e.g., dimensions of the vehicle's interior, dimensions of the seat area for installation of the vehicle such as height, length, and/or depth, etc.), seat parameters (e.g., dimensions of the vehicle seat such as height, length, and/or depth, weight limit of the seat, etc.), seat data (e.g., information of manufactures of vehicle seats, listing of vehicle seat manufacturers, listing of vehicle seats available to purchase, dimensions of vehicle seats available for purchase, weight limit of vehicle seats available for purchase, etc.), and/or other data (e.g., price of vehicle seats available for purchase, reviews of seats available for purchase, list of stores selling vehicle seats, information of stores selling vehicle seats, location of stores selling vehicle seats, product information of vehicle seats available for purchase, reviews of vehicle seats available for purchase, etc.). Any of the foregoing input data may be submitted by the requestor from a prior vehicle seat recommendation request, determined by a predictive replacement time system (e.g., the application server 220), and/or pulled by the predictive replacement time system over one or more networks.

The method 800 may proceed to block 806 by determining, by the one or more processors, a set of characteristics of the input data.

The set of characteristics may include classifications, categories, fields, entries, parameters, values, interconnected data, etc. related to and/or derived from prior input data (e.g., user entered data, determined data, and/or pulled data as described herein).

The method 800 may proceed to block 808 by applying, by the one or more processors, the set of characteristics of the input data to the machine learning model to determine the predictive replacement time for replacing the one or more vehicle seats.

The method 800 may proceed to block 810 by providing, by the one or more processors, an indication of the predictive replacement time for display on a client device (e.g., the user device 202).

### Additional Exemplary Embodiments: Vehicle Seat Recommendation System

In one aspect, a computer-implemented method for recommending a vehicle seat may be provided. The method may be implemented via one or more local and/or remote processors, transceivers, sensors, servers, memory units, mobile devices, wearables, smart glasses, augmented reality glasses, virtual reality headsets, and/or other electronic and/or electrical components. In one instance, the method may include: (1) training, by one or more processors, a machine learning model using a set of characteristics of previously recommended vehicle seats to generate a vehicle seat recommendation score for one or more vehicle seats; (2) receiving, by the one or more processors, a request for a vehicle seat recommendation; (3) receiving, by the one or more processors, input data; (4) determining, by the one or more processors, a set of characteristics of the input data; (5) applying, by the one or more processors, the set of characteristics of the input data to the machine learning model to generate a vehicle seat recommendation score for the one or more vehicle seats; (6) ranking, by the one or more processors, the one or more vehicle seats by vehicle seat recommendation score to generate a vehicle seat recommendation list; and/or (7) presenting, by the one or more processors, the vehicle seat recommendation list to a client device. The method may include additional, less, or alternate actions, including those discussed elsewhere herein.

For instance, additionally or alternatively to the foregoing method, wherein the input data and/or the set of characteristics may include one or more of child and/or toddler data, vehicle data, current seat data, location data, vehicle interior parameters data, seat parameters data, on-market seat data, seat reviews, seat prices, and/or seat stock information.

Additionally or alternatively to the foregoing method, wherein (i) the child and/or toddler data may include one or more data of toddler, child, adolescent, and/or adult age, toddler, child, adolescent, and/or adult height, and/or toddler, child, adolescent, and/or adult weight; (ii) the vehicle data may include one or more of vehicle year, vehicle make, and/or vehicle model; (iii) the current seat data may include one or more of seat brand, seat product name, and/or seat serial number; (iv) the location data may include one or more of geolocation of the requestor, address of the requestor, and/or zip code of the requestor; (v) the vehicle interior parameters data may include one or more data of dimensions of an interior of the vehicle and/or dimensions of a seat area of the vehicle; (vi) the seat parameters data may include one or more of dimensions of the seat and/or weight limit of the seat; and/or (vii) on-market seat data may include one or more of list of one or more seat manufacturers, list of one or more vehicle seats per manufacturer, dimensions of one or more vehicle seats per manufacturer, or weight limit of one or more vehicle seats per manufacturer.

Additionally or alternatively to the foregoing method, determining the set of characteristics of the input data may further include: determining, by the one or more processors, vehicle interior parameters based upon the input data; determining, by the one or more processors, seat parameters based upon the input data; and/or retrieving, by the one or more processors from one or more networks, seat data which may include one or more of on-market seat data, seat reviews, seat prices, and/or seat stock information.

Additionally or alternatively to the foregoing method, training the machine learning model may further include: recommending, by the one or more processors, a vehicle seat based upon a set of previously recommended vehicle seats and the set of characteristics of the previously recommended vehicle seats; determining, by the one or more processors, a prior requestor selected the recommended vehicle seat; reducing, by the one or more processors, the percent rate of error of determining the prior requestor selected the recommended vehicle seat r; and/or generating, by the one or more processors, a confidence interval based upon the recommended vehicle seat, the selected vehicle seat made by the prior requestor, and/or one or more standard deviations from an output of the machine learning model.

Additionally or alternatively to the foregoing method, the method may further include: determining, by the one or more processors, a vehicle seat selection pool based upon one or more of the child height, the child weight, vehicle seat parameters data, or on-market data, wherein the one or more vehicle seats is selected from the vehicle seat selection pool; determining, by the one or more processors, locations of one or more stores selling the one or more vehicle seats based upon seat stock information; identifying, by the one or more processors, the one or more stores closest in position to input location data; sorting, by the one or more processors, the one or more stores based upon the seat recommendation list and/or the seat stock information; presenting, by the one or more processors, the one or more sorted stores; and/or ordering, by the one or more processors, a vehicle seat from a store wherein the vehicle seat may be selected by the requestor from the seat recommendation list and/or the store may be selected by the requestor from the one or more sorted stores.

In another aspect, a computer system for recommending a vehicle seat may be provided. The computer system may be configured to include one or more local and/or remote processors, transceivers, sensors, servers, memory units, mobile devices, wearables, smart glasses, augmented reality glasses, virtual reality headsets, and/or other electronic and/or electrical components. In one instance, the computer system may include one or more processors; and/or a non-transitory program memory coupled to the one or more processors and/or storing executable instructions that, when executed by the one or more processors, cause the computer system to: (1) train a machine learning model using a set of characteristics of previously recommended vehicle seats to generate a vehicle seat recommendation score for one or more vehicle seats; (2) receive a request for a vehicle seat recommendation; (3) receiving, by the one or more processors, input data; (4) determine a set of characteristics of the input data; (5) apply the set of characteristics of the input data to the machine learning model to generate a vehicle seat recommendation score for the one or more vehicle seats; (6) rank the one or more vehicle seats by vehicle seat recommendation score to generate a vehicle seat recommendation list; and/or (7) present the vehicle seat recommendation list to a client device. The computer system may be configured to include additional, less, or alternate functionality, including that discussed elsewhere herein.

For instance, additionally or alternatively to the foregoing system, wherein the input data and/or the set of characteristics may include one or more of child and/or toddler data, vehicle data, current seat data, location data, vehicle interior parameters data, seat parameters data, on-market seat data, seat reviews, seat prices, and/or seat stock information. Additionally or alternatively to the foregoing system, wherein (i) the child and/or toddler data may include one or more data of toddler, child, adolescent, and/or adult age, toddler, child, adolescent, and/or adult height, and/or toddler, child, adolescent, and/or adult weight; (ii) the vehicle data may include one or more of vehicle year, vehicle make, and/or vehicle model; (iii) the current seat data may include one or more of seat brand, seat product name, and/or seat serial number; (iv) the location data may include one or more of geolocation of the requestor, address of the requestor, and/or zip code of the requestor; (v) the vehicle interior parameters data may include one or more data of dimensions of an interior of the vehicle and/or dimensions of a seat area of the vehicle; (vi) the seat parameters data may include one or more of dimensions of the seat and/or weight limit of the seat; and/or (vii) on-market seat data may include one or more of list of one or more seat manufacturers, list of one or more vehicle seats per manufacturer, dimensions of one or more vehicle seats per manufacturer, and/or weight limit of one or more vehicle seats per manufacturer.

Additionally or alternatively to the foregoing system, determining the set of characteristics of the input data may further cause the system to: determine vehicle interior parameters based upon the input data; determine seat parameters based upon the input data; and/or retrieve, from one or more networks, seat data which may include one or more of on-market seat data, seat reviews, seat prices, and/or seat stock information.

Additionally or alternatively to the foregoing system, training the machine learning model may further cause the system to: recommend a vehicle seat based upon a set of previously recommended vehicle seats and the set of characteristics of the previously recommended vehicle seats; determine a prior requestor selected the recommended vehicle seat; reduce the percent rate of error of determining the prior requestor selected the recommended vehicle seat; and/or generate a confidence interval based upon the recommended vehicle seat, the selected vehicle seat made by the prior requestor, and/or one or more standard deviations from an output of the machine learning model.

Additionally or alternatively to the foregoing system, the instructions may further cause the system to: determine a vehicle seat selection pool based upon one or more of the child height, the child weight, vehicle seat parameters data, or on-market data, wherein the one or more vehicle seats is selected from the vehicle seat selection pool; determine locations of one or more stores selling the one or more vehicle seats based upon seat stock information; identify the one or more stores closest in position to input location data; sort the one or more stores based upon the seat recommendation list and/or the seat stock information; present, by the one or more processors, the one or more sorted stores; and/or order a vehicle seat from a store wherein the vehicle seat may be selected by the requestor from the seat recommendation list and/or the store may be selected by the requestor from the one or more sorted stores.

In another aspect, a tangible, a non-transitory computer-readable medium may store executable instructions for recommending a vehicle seat may be provided. The executable instructions, when executed, may cause one or more processors to: (1) train a machine learning model using a set of characteristics of previously recommended vehicle seats to generate a vehicle seat recommendation score for one or more vehicle seats; (2) receive a request for a vehicle seat recommendation; (3) receiving, by the one or more processors, input data; (4) determine a set of characteristics of the input data; (5) apply the set of characteristics of the input data to the machine learning model to generate a vehicle seat recommendation score for the one or more vehicle seats; (6) rank the one or more vehicle seats by vehicle seat recommendation score to generate a vehicle seat recommendation list; and/or (7) present the vehicle seat recommendation list to a client device. The instructions may direct additional, less, or alternate functionality, including that discussed elsewhere herein.

For instance, additionally or alternatively to the foregoing executable instructions, wherein the input data and/or the set of characteristics may include one or more of child and/or toddler data, vehicle data, current seat data, location data, vehicle interior parameters data, seat parameters data, on-market seat data, seat reviews, seat prices, and/or seat stock information. Additionally or alternatively to the foregoing executable instructions, wherein (i) the child and/or toddler data may include one or more data of toddler, child, adolescent, and/or adult age, toddler, child, adolescent, and/or adult height, and/or toddler, child, adolescent, and/or adult weight; (ii) the vehicle data may include one or more of vehicle year, vehicle make, and/or vehicle model; (iii) the current seat data may include one or more of seat brand, seat product name, and/or seat serial number; (iv) the location data may include one or more of geolocation of the requestor, address of the requestor, and/or zip code of the requestor; (v) the vehicle interior parameters data may include one or more data of dimensions of an interior of the vehicle and/or dimensions of a seat area of the vehicle; (vi) the seat parameters data may include one or more of dimensions of the seat and/or weight limit of the seat; and/or (vii) on-market seat data may include one or more of list of one or more seat manufacturers, list of one or more vehicle seats per manufacturer, dimensions of one or more vehicle seats per manufacturer, and/or weight limit of one or more vehicle seats per manufacturer.

Additionally or alternatively to the foregoing executable instructions, determining the set of characteristics of the input data may further cause the one or more processors to: determine vehicle interior parameters based upon the input data; determine seat parameters based upon the input data; and/or retrieve, from one or more networks, seat data which may include one or more of on-market seat data, seat reviews, seat prices, and/or seat stock information.

Additionally or alternatively to the foregoing executable instructions, training the machine learning model may further cause the one or more processors to: recommend a vehicle seat based upon a set of previously recommended vehicle seats and the set of characteristics of the previously recommended vehicle seats; determine a prior requestor selected the recommended vehicle seat; reduce the percent rate of error of determining the prior requestor selected the recommended vehicle seat; and/or generate a confidence interval based upon the recommended vehicle seat, the selected vehicle seat made by the prior requestor, and/or one or more standard deviations from an output of the machine learning model.

Additionally or alternatively to the foregoing executable instructions, the executable instructions may further cause the one or more processors to: determine a vehicle seat selection pool based upon one or more of the child height, the child weight, vehicle seat parameters data, or on-market data, wherein the one or more vehicle seats is selected from the vehicle seat selection pool; determine locations of one or more stores selling the one or more vehicle seats based upon seat stock information; identify the one or more stores closest in position to input location data; sort the one or more stores based upon the seat recommendation list and/or the seat stock information; present, by the one or more processors, the one or more sorted stores; and/or order a vehicle seat from a store wherein the vehicle seat may be selected by the requestor from the seat recommendation list and/or the store may be selected by the requestor from the one or more sorted stores.

### Additional Exemplary Embodiments: Predictive Replacement Time of Vehicle Seat System

In one aspect, a computer-implemented method for predicting the replacement time of a vehicle seat may be provided. The method may be implemented via one or more local and/or remote processors, transceivers, sensors, servers, memory units, mobile devices, wearables, smart glasses, augmented reality glasses, virtual reality headsets, and/or other electronic and/or electrical components. In one instance, the method may include: (1) training, by one or more processors, a machine learning model for predicting a replacement time of one or more vehicle seats using (i) a set of characteristics of a previously recommended vehicle seat and/or (ii) replacement times for the previously recommended vehicle seat; (2) receiving, by the one or more processors, input data related to a previously recommended vehicle seat; (3) determining, by the one or more processors, a set of characteristics of the input data; (4) applying, by the one or more processors, the set of characteristics of the input data to the machine learning model to determine the predictive replacement time for replacing the one or more vehicle seats; and/or (5) providing, by the one or more processors, an indication of the predictive replacement time for display on a client device. The method may include additional, less, or alternate actions, including those discussed elsewhere herein.

For instance, additionally or alternatively to the foregoing method, wherein the input data and/or the set of characteristics may include one or more of child and/or toddler data, vehicle data, current seat data, location data, vehicle interior parameters data, seat parameters data, on-market seat data, seat reviews, seat prices, and/or seat stock information.

Additionally or alternatively to the foregoing method, wherein (i) the child and/or toddler data may include one or more data of toddler, child, adolescent, and/or adult age, toddler, child, adolescent, and/or adult height, and/or toddler, child, adolescent, and/or adult weight; (ii) the vehicle data may include one or more of vehicle year, vehicle make, and/or vehicle model; (iii) the current seat data may include one or more of seat brand, seat product name, and/or seat serial number; (iv) the location data may include one or more of geolocation of the requestor, address of the requestor, and/or zip code of the requestor; (v) the vehicle interior parameters data may include one or more data of dimensions of an interior of the vehicle and/or dimensions of a seat area of the vehicle; (vi) the seat parameters data may include one or more of dimensions of the seat and/or weight limit of the seat; and/or (vii) on-market seat data may include one or more of list of one or more seat manufacturers, list of one or more vehicle seats per manufacturer, dimensions of one or more vehicle seats per manufacturer, and/or weight limit of one or more vehicle seats per manufacturer.

Additionally or alternatively to the foregoing method, training the machine learning model may further include: predicting, by the one or more processors, a replacement time of a vehicle seat based upon a set of previously recommended vehicle seats, the set of characteristics of the previously recommended vehicle seats, and time interval between prior vehicle seat recommendation requests; determining, by the one or more processors, the accuracy of the predicted replacement time; reducing, by the one or more processors, the percent rate of error of predicting the replacement time; and/or generating, by the one or more processors, a confidence interval based upon the predicted replacement time, the time interval between prior vehicle seat recommendation requests, and/or one or more standard deviations from an output of the machine learning model.

Additionally or alternatively to the foregoing method, the method may further include: determining, by the one or more processors, a determined growth rate based upon one or more of a prior child height or a prior child weight; determining, by the one or more processors, the child height and the child weight based upon the growth rate; retrieving, by the one or more processors from one or more networks, seat data which may include one or more of on-market seat data, seat reviews, seat prices, and/or seat stock information, wherein on-market seat data may include one or more of list of one or more vehicle seat manufacturers, list of one or more vehicle seats per manufacturer, dimensions of one or more vehicle seats per manufacturer, and/or weight limit of one or more seats per manufacturer; generating, by the one or more processors, a seat recommendation score for one or more replacement vehicle seats based upon the input data and/or the seat data; ranking, by the one or more processors, the one or more replacement vehicle seats by seat recommendation score to generate a seat recommendation list; determining, by the one or more processors, locations of one or more stores selling the one or more replacement vehicle seats based upon seat stock information; identifying, by the one or more processors, the one or more stores closest in position to input location data; sorting, by the one or more processors, the one or more stores based upon the seat recommendation list and/or the seat stock information; and/or ordering, by the one or more processors, a vehicle seat from a store wherein the vehicle seat may be selected from the seat recommendation list and/or the store may be selected from the one or more sorted stores.

In another aspect, a computer system for predicting the replacement time of a vehicle seat may be provided. The computer system may include one or more local and/or remote processors, transceivers, sensors, servers, memory units, mobile devices, wearables, smart glasses, augmented reality glasses, virtual reality headsets, and/or other electronic and/or electrical components. In one instance, the computer system may include one or more processors; and/or a non-transitory program memory coupled to the one or more processors and/or storing executable instructions that, when executed by the one or more processors, cause the computer system to: (1) train a machine learning model for predicting a replacement time of one or more vehicle seats using (i) a set of characteristics of a previously recommended vehicle seat and/or (ii) replacement times for the previously recommended vehicle seat; (2) receive input data related to a previously recommended vehicle seat; (3) determine a set of characteristics of the input data; (4) apply the set of characteristics of the input data to the machine learning model to determine the predictive replacement time for replacing the one or more vehicle seats; and/or (5) provide an indication of the predictive replacement time for display on a client device. The computer system may include additional, less, or alternate functionality, including that discussed elsewhere herein.

For instance, additionally or alternatively to the foregoing system, wherein the input data and/or the set of characteristics may include one or more of child and/or toddler data, vehicle data, current seat data, location data, vehicle interior parameters data, seat parameters data, on-market seat data, seat reviews, seat prices, and/or seat stock information.

Additionally or alternatively to the foregoing system, wherein (i) the child and/or toddler data may include one or more data of toddler, child, adolescent, and/or adult age, toddler, child, adolescent, and/or adult height, and/or toddler, child, adolescent, and/or adult weight; (ii) the vehicle data may include one or more of vehicle year, vehicle make, and/or vehicle model; (iii) the current seat data may include one or more of seat brand, seat product name, and/or seat serial number; (iv) the location data may include one or more of geolocation of the requestor, address of the requestor, and/or zip code of the requestor; (v) the vehicle interior parameters data may include one or more data of dimensions of an interior of the vehicle and/or dimensions of a seat area of the vehicle; (vi) the seat parameters data may include one or more of dimensions of the seat and/or weight limit of the seat; and/or (vii) on-market seat data may include one or more of list of one or more seat manufacturers, list of one or more vehicle seats per manufacturer, dimensions of one or more vehicle seats per manufacturer, and/or weight limit of one or more vehicle seats per manufacturer.

Additionally or alternatively to the foregoing system, training the machine learning model may further cause the system to: predict a replacement time of a vehicle seat based upon a set of previously recommended vehicle seats, the set of characteristics of the previously recommended vehicle seats, and time interval between prior vehicle seat recommendation requests; determine the accuracy of the predicted replacement time; reduce the percent rate of error of predicting the replacement time; and/or generate a confidence interval based upon the predicted replacement time, the time interval between prior vehicle seat recommendation requests, and/or one or more standard deviations from an output of the machine learning model.

Additionally or alternatively to the foregoing system, the instructions may further cause the system to: determine a determined growth rate based upon one or more of a prior child height or a prior child weight; determine the child height and the child weight based upon the growth rate; retrieve, from one or more networks, seat data which may include one or more of on-market seat data, seat reviews, seat prices, and/or seat stock information, wherein on-market seat data may include one or more of list of one or more vehicle seat manufacturers, list of one or more vehicle seats per manufacturer, dimensions of one or more vehicle seats per manufacturer, and/or weight limit of one or more seats per manufacturer; generate a seat recommendation score for one or more replacement vehicle seats based upon the input data and/or the seat data; rank the one or more replacement vehicle seats by seat recommendation score to generate a seat recommendation list; determine locations of one or more stores selling the one or more replacement vehicle seats based upon seat stock information; identify the one or more stores closest in position to input location data; sort the one or more stores based upon the seat recommendation list and/or the seat stock information; and/or order a vehicle seat from a store wherein the vehicle seat may be selected from the seat recommendation list and/or the store may be selected from the one or more sorted stores.

In another aspect, a tangible, a non-transitory computer-readable medium may store executable instructions for predicting the replacement time of a vehicle seat may be provided. The executable instructions, when executed, may cause one or more processors to: (1) train a machine learning model for predicting a replacement time of one or more vehicle seats using (i) a set of characteristics of a previously recommended vehicle seat and (ii) replacement times for the previously recommended vehicle seat; (2) receive input data related to a previously recommended vehicle seat; (3) determine a set of characteristics of the input data; (4) apply the set of characteristics of the input data to the machine learning model to determine the predictive replacement time for replacing the one or more vehicle seats; and/or (5) provide an indication of the predictive replacement time for display on a client device. The instructions may direct additional, less, or alternate functionality, including that discussed elsewhere herein.

For instance, additionally or alternatively to the foregoing executable instructions, wherein the input data and/or the set of characteristics may include one or more of child and/or toddler data, vehicle data, current seat data, location data, vehicle interior parameters data, seat parameters data, on-market seat data, seat reviews, seat prices, and/or seat stock information.

Additionally or alternatively to the foregoing executable instructions, wherein (i) the child and/or toddler data may include one or more data of toddler, child, adolescent, and/or adult age, toddler, child, adolescent, and/or adult height, and/or toddler, child, adolescent, and/or adult weight; (ii) the vehicle data may include one or more of vehicle year, vehicle make, and/or vehicle model; (iii) the current seat data may include one or more of seat brand, seat product name, and/or seat serial number; (iv) the location data may include one or more of geolocation of the requestor, address of the requestor, and/or zip code of the requestor; (v) the vehicle interior parameters data may include one or more data of dimensions of an interior of the vehicle and/or dimensions of a seat area of the vehicle; (vi) the seat parameters data may include one or more of dimensions of the seat and/or weight limit of the seat; and/or (vii) on-market seat data may include one or more of list of one or more seat manufacturers, list of one or more vehicle seats per manufacturer, dimensions of one or more vehicle seats per manufacturer, and/or weight limit of one or more vehicle seats per manufacturer.

Additionally or alternatively to the foregoing executable instructions, training the machine learning model may further cause the one or more processors to: predict a replacement time of a vehicle seat based upon a set of previously recommended vehicle seats, the set of characteristics of the previously recommended vehicle seats, and time interval between prior vehicle seat recommendation requests; determine the accuracy of the predicted replacement time; reduce the percent rate of error of predicting the replacement time; and/or generate a confidence interval based upon the predicted replacement time, the time interval between prior vehicle seat recommendation requests, and/or one or more standard deviations from an output of the machine learning model.

Additionally or alternatively to the foregoing executable instructions, the executable instructions may further cause the one or more processors to: determine a determined growth rate based upon one or more of a prior child height or a prior child weight; determine the child height and the child weight based upon the growth rate; retrieve, from one or more networks, seat data which may include one or more of on-market seat data, seat reviews, seat prices, and/or seat stock information, wherein on-market seat data may include one or more of list of one or more vehicle seat manufacturers, list of one or more vehicle seats per manufacturer, dimensions of one or more vehicle seats per manufacturer, and/or weight limit of one or more seats per manufacturer; generate a seat recommendation score for one or more replacement vehicle seats based upon the input data and/or the seat data; rank the one or more replacement vehicle seats by seat recommendation score to generate a seat recommendation list; determine locations of one or more stores selling the one or more replacement vehicle seats based upon seat stock information; identify the one or more stores closest in position to input location data; sort the one or more stores based upon the seat recommendation list and/or the seat stock information; and/or order a vehicle seat from a store wherein the vehicle seat may be selected from the seat recommendation list and/or the store may be selected from the one or more sorted stores.

### Additional Considerations

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, some embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more modules of a computer system (e.g., a processor or a group of processors) may be configured by software (e.g., an application or application portion) as a module that operates to perform certain operations as described herein.

In various embodiments, a module may be implemented mechanically or electronically. Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules are temporarily configured (e.g., programmed), each of the modules need not be configured or instantiated at any one instance in time. For example, where the modules comprise a general-purpose processor configured using software, the general-purpose processor may be configured as respective different modules at different times. Software may accordingly configure a processor, for example, to constitute a particular module at one instance of time and to constitute a different module at a different instance of time.

Modules may provide information to, and receive information from, other modules. Accordingly, the described modules may be regarded as being communicatively coupled. Where multiple of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may, at a later time, access the memory device to retrieve and process the stored output. Modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

Unless specifically stated otherwise, discussions herein using words such as “receiving,” “analyzing,” “generating,” “creating,” “storing,” “deploying,” “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information. Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other.

As used herein any reference to “some embodiments” means that a particular element, feature, structure, or characteristic described in connection with the embodiment may be included in at least one embodiment. The appearances of the phrase “some embodiments” in various places in the specification are not necessarily all referring to the same embodiment. In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

This detailed description is to be construed as exemplary only and does not describe every possible embodiment, as describing every possible embodiment would be impractical, if not impossible. One could implement numerous alternate embodiments, using either current technology or technology developed after the filing date of this application. Upon reading this disclosure, those of skill in the art will appreciate still additional alternative structural and functional designs for system and a method for assigning mobile device data to a vehicle through the disclosed principles herein.

Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein. It is therefore intended that the foregoing detailed description be regarded as illustrative rather than limiting, and that it be understood that it is the following claims, including all equivalents, that are intended to define the spirit and scope of this invention.

What is claimed:

1. A computer-implemented method for predicting a time to replace one or more vehicle seats, the method comprising:
training, by one or more processors, a machine learning model for predicting a replacement time of one or more vehicle seats using (i) a set of characteristics of a previously recommended vehicle seat and (ii) replacement times for the previously recommended vehicle seat, wherein the machine learning model includes one or more layers having one or more corresponding weights, and training the machine learning model includes:
determining whether a validation metric associated with the machine learning is satisfied, and
when the validation metric is satisfied, retraining the machine learning model by modifying the one or more weights;
receiving, by the one or more processors, input data related to a previously recommended vehicle seat;
determining, by the one or more processors, a set of characteristics of the input data;
applying, by the one or more processors, the set of characteristics of the input data to the machine learning model to determine the predictive replacement time for replacing the one or more vehicle seats; and
providing, by the one or more processors, an indication of the predictive replacement time for display on a client device.

2. The computer-implemented method of claim 1, wherein:
(i) the set of characteristics includes one or more of child data, vehicle data, current vehicle seat data, location data, or date data;
(ii) input data includes one or more of child data, vehicle data, current vehicle seat data, location data, or date data;
(iii) the child data includes one or more data of child age, child height, or child weight;
(iv) the vehicle data includes one or more of vehicle year, vehicle make, or vehicle model;
(v) the current vehicle seat data includes one or more of vehicle seat brand, vehicle seat product name, or vehicle seat serial number;
(vi) the location data includes one or more of geolocation of a requestor, address of the requestor, or zip code of the requestor.

3. The computer-implemented method of claim 1, further comprising:
determining, by the one or more processors, a determined growth rate based upon one or more of a prior child height or a prior child weight; and
determining, by the one or more processors, the child height and the child weight based upon the growth rate.

4. The computer-implemented method of claim 3, further comprising:
retrieving, by the one or more processors from one or more networks, vehicle seat data, wherein (i) the vehicle seat data includes one or more of on-market vehicle seat data, vehicle seat reviews, vehicle seat prices, or vehicle seat stock information and (ii) on-market vehicle seat data includes one or more of list of one or more vehicle seat manufacturers, list of one or more vehicle seats per manufacturer, dimensions of one or more vehicle seats per manufacturer, or weight limit of one or more vehicle seats per manufacturer;
generating, by the one or more processors, a vehicle seat recommendation score for one or more replacement vehicle seats based upon the input data and the vehicle seat data; and
ranking, by the one or more processors, the one or more replacement vehicle seats by vehicle seat recommendation score to generate a vehicle seat recommendation list.

5. The computer-implemented method of claim 4, further comprising:
determining, by the one or more processors, locations of one or more stores selling the one or more replacement vehicle seats based upon vehicle seat stock information;
identifying, by the one or more processors, the one or more stores closest in position to input location data;
sorting, by the one or more processors, the one or more stores based upon the vehicle seat recommendation list and the vehicle seat stock information; and
presenting, by the one or more processors, the one or more sorted stores to the client device.

6. The computer-implemented method of claim 1, wherein training the machine learning model comprises:
predicting, by the one or more processors, a replacement time of a vehicle seat based upon a set of previously recommended vehicle seats, the set of characteristics of the previously recommended vehicle seats, and time interval between prior vehicle seat recommendation requests; and
determining, by the one or more processors, an accuracy of the predicted replacement time.

7. The computer-implemented method of claim 6, wherein training the machine learning model comprises:
reducing, by the one or more processors, a percent rate of error of predicting the replacement time; and
generating, by the one or more processors, a confidence interval based upon one or more of (i) the predicted replacement time, (ii) the time interval between prior vehicle seat recommendation requests, and/or (iii) one or more standard deviations from an output of the machine learning model.

8. A computer system for predicting a time to replace one or more vehicle seats, comprising:
one or more processors;
a non-transitory program memory coupled to the one or more processors and storing executable instructions that, when executed by the one or more processors, cause the computer system to:
train a machine learning model for predicting a replacement time of one or more vehicle seats using (i) a set of characteristics of a previously recommended vehicle seat and (ii) replacement times for the previously recommended vehicle seat, wherein the machine learning model includes one or more layers having one or more corresponding weights, and training the machine learning model includes:
determining whether a validation metric associated with the machine learning is satisfied, and
when the validation metric is satisfied, retraining the machine learning model by modifying the one or more weights;
receive input data related to a previously recommended vehicle seat;
determine a set of characteristics of the input data;
apply the set of characteristics of the input data to the machine learning model to determine the predictive replacement time for replacing the one or more vehicle seats; and
provide an indication of the predictive replacement time for display on a client device.

9. The computer system of claim 8, wherein:
(i) the set of characteristics includes one or more of child data, vehicle data, current vehicle seat data, location data, or date data;
(ii) input data includes one or more of child data, vehicle data, current vehicle seat data, location data, or date data;
(iii) the child data includes one or more data of child age, child height, or child weight;
(iv) the vehicle data includes one or more of vehicle year, vehicle make, or vehicle model;
(v) the current vehicle seat data includes one or more of vehicle seat brand, vehicle seat product name, or vehicle seat serial number;
(vi) the location data includes one or more of geolocation of a requestor, address of the requestor, or zip code of the requestor.

10. The computer system of claim 8, wherein the executable instructions, when executed by the one or more processors, further cause the computer system to:
determine a determined growth rate based upon one or more of a prior child height or a prior child weight; and
determine the child height and the child weight based upon the growth rate.

11. The computer system of claim 10, wherein the executable instructions, when executed by the one or more processors, further cause the computer system to:
retrieve, from one or more networks, vehicle seat data, wherein (i) the vehicle seat data includes one or more of on-market vehicle seat data, vehicle seat reviews, vehicle seat prices, or vehicle seat stock information and (ii) on-market vehicle seat data includes one or more of list of one or more vehicle seat manufacturers, list of one or more vehicle seats per manufacturer, dimensions of one or more vehicle seats per manufacturer, or weight limit of one or more vehicle seats per manufacturer;
generate a vehicle seat recommendation score for one or more replacement vehicle seats based upon the input data and the vehicle seat data; and
rank the one or more replacement vehicle seats by vehicle seat recommendation score to generate a vehicle seat recommendation list.

12. The computer system of claim 11, wherein the executable instructions, when executed by the one or more processors, further cause the computer system to:
determine locations of one or more stores selling the one or more replacement vehicle seats based upon vehicle seat stock information;
identify the one or more stores closest in position to input location data;
sort the one or more stores based upon the vehicle seat recommendation list and the vehicle seat stock information;
presenting, by the one or more processors, the one or more sorted stores to the client device.

13. The computer system of claim 8, wherein to train the machine learning model, the executable instructions, when executed by the one or more processors, cause the computer system to:
predict a replacement time of a vehicle seat based upon a set of previously recommended vehicle seats, the set of characteristics of the previously recommended vehicle seats, and time interval between prior vehicle seat recommendation requests; and
determine an accuracy of the predicted replacement time.

14. The computer system of claim 13, wherein to train the machine learning model, the executable instructions, when executed by the one or more processors, cause the computer system to:
reduce a percent rate of error of predicting the replacement time by; and
generate a confidence interval based upon one or more of: (i) the predicted replacement time, (ii) the time interval between prior vehicle seat recommendation requests, and/or (iii) one or more standard deviations from an output of the machine learning model.

15. A tangible, non-transitory computer-readable medium storing executable instructions for predicting a time to replace one or more vehicle seats, the instructions, when executed by one or more processors of a computer system, cause the computer system to:
train a machine learning model for predicting a replacement time of one or more vehicle seats using (i) a set of characteristics of a previously recommended vehicle seat and (ii) replacement times for the previously recommended vehicle seat, wherein the machine learning model includes one or more layers having one or more corresponding weights, and training the machine learning model includes:
determining whether a validation metric associated with the machine learning is satisfied, and
when the validation metric is satisfied, retraining the machine learning model by modifying the one or more weights;
receive input data related to a previously recommended vehicle seat;
determine a set of characteristics of the input data;
apply the set of characteristics of the input data to the machine learning model to determine the predictive replacement time for replacing the one or more vehicle seats; and
provide an indication of the predictive replacement time for display on a client device.

16. The tangible, non-transitory computer-readable medium of claim 15, wherein:
(i) the set of characteristics includes one or more of child data, vehicle data, current vehicle seat data, location data, or date data;
(ii) input data includes one or more of child data, vehicle data, current vehicle seat data, location data, or date data;
(iii) the child data includes one or more data of child age, child height, or child weight;
(iv) the vehicle data includes one or more of vehicle year, vehicle make, or vehicle model;
(v) the current vehicle seat data includes one or more of vehicle seat brand, vehicle seat product name, or vehicle seat serial number;
(vi) the location data includes one or more of geolocation of a requestor, address of the requestor, or zip code of the requestor.

17. The tangible, non-transitory computer-readable medium of claim 15, wherein the executable instructions, when executed by the one or more processors, further cause the computer system to:
determine a determined growth rate based upon one or more of a prior child height or a prior child weight; and
determine the child height and the child weight based upon the growth rate.

18. The tangible, non-transitory computer-readable medium of claim 17, wherein the executable instructions, when executed by the one or more processors, further cause the computer system to:
retrieve, from one or more networks, vehicle seat data, wherein (i) the vehicle seat data includes one or more of on-market vehicle seat data, vehicle seat reviews, vehicle seat prices, or vehicle seat stock information and (ii) on-market vehicle seat data includes one or more of list of one or more vehicle seat manufacturers, list of one or more vehicle seats per manufacturer, dimensions of one or more vehicle seats per manufacturer, or weight limit of one or more vehicle seats per manufacturer;
generate a vehicle seat recommendation score for one or more replacement vehicle seats based upon the input data and the vehicle seat data; and
rank the one or more replacement vehicle seats by vehicle seat recommendation score to generate a vehicle seat recommendation list.

19. The tangible, non-transitory computer-readable medium of claim 18, wherein the executable instructions, when executed by the one or more processors, further cause the computer system to:
determine locations of one or more stores selling the one or more replacement vehicle seats based upon vehicle seat stock information;
identify the one or more stores closest in position to input location data;
sort the one or more stores based upon the vehicle seat recommendation list and the vehicle seat stock information;
presenting, by the one or more processors, the one or more sorted stores to the client device.

20. The tangible, non-transitory computer-readable medium of claim 15, wherein to train the machine learning model, the executable instructions, when executed by the one or more processors, cause the computer system to:
predict a replacement time of a vehicle seat based upon a set of previously recommended vehicle seats, the set of characteristics of the previously recommended vehicle seats, and time interval between prior vehicle seat recommendation requests;
determine an accuracy of the predicted replacement time;
reduce a percent rate of error of predicting the replacement time; and
generate a confidence interval based upon one or more of: (i) the predicted replacement time, (ii) the time interval between prior vehicle seat recommendation requests, and/or (iii) one or more standard deviations from an output of the machine learning model.
